(19) United States
(12) Patent Application Publication
(10) Pub. No.: US 2023/0107409 A1
(43) Pub. Date: Apr. 6, 2023

(54) ENSEMBLING MIXTURE-OF-EXPERTS NEURAL NETWORKS

(71) Applicant: Google LLC, Mountain View, CA (US)

(72) Inventors: Rodolphe Jenatton, Berlin (DE); Carlos Riquelme Ruiz, Zurich (CH); Dustin Tran, Mountain View, CA (US); James Urquhart Allingham, Cambridge (GB); Florian Wenzel, Berlin (DE); Zelda Elaine Mariet, Cambridge, MA (US); Basil Mustafa, Zurich (CH); Joan Puigcerver i Perez, Zurich (CH); Neil Matthew Tinmouth Houlsby, Zurich (CH); Ghassen Jerfel, Berkeley, CA (US)

(21) Appl. No.: 17/960,780

(22) Filed: Oct. 5, 2022

Related U.S. Application Data
(60) Provisional application No. 63/252,614, filed on Oct. 5, 2021.

(51) Int. Cl. G06N 3/04

(52) U.S. Cl. CPC G06N 3/0454

(57) ABSTRACT

Methods, systems, and apparatus, including computer programs encoded on a computer storage medium, for performing a machine learning task on a network input to generate a network output. In one aspect, one of the systems includes a neural network configured to perform the machine learning task, the neural network including one or more expert neural network blocks that each include multiple routers and multiple expert neural networks.

### CROSS-REFERENCE TO RELATED APPLICATION

This application claims priority to U.S. Provisional Application No. 63/252,614, filed on Oct. 5, 2021. The disclosure of the prior application is considered part of and is incorporated by reference in the disclosure of this application.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates network outputs for received network inputs using a neural network that includes one or more “expert” network blocks. Each expert network block includes (i) multiple different expert neural networks and (ii) multiple different routers that are each configured to route the block input of the expert network block (or a routing input determined from the block input) to one or more respective expert neural networks.

Particular embodiments of the subject matter described in this specification can be implemented so as to realize one or more of the following advantages.

Using techniques described in this specification, a system can process network inputs using a neural network by selectively activating subsets of the parameters of the neural network based on the network input, significantly improving the time and computational efficiency of the neural network. Introducing this sparsity can allow the neural network to include many more network parameters than was previously feasible, since only a subset of the parameters are used to process any given input.

Furthermore, using techniques described in this specification, a system can process a network input using respective different sequences of routers to generate respective different initial network outputs, and combine the initial network outputs to generate a final network output. Each initial network output can represent a different prediction for the same machine learning task. By combining the different predictions, the system can improve the robustness and accuracy of the final prediction.

For instance, as described above, when processing a network input using the neural network, the system can maintain k different representations of the network input. At each expert network block of the neural network, the system can process each representation using a respective different router to update the representation. Thus, the multiple initial network outputs have been generated using a different set of trained network parameters, and thus can each encode different information about the network input that is relevant for the machine learning task.

In some implementations described in this specification, each expert neural network can be configured through training to process different types of network inputs, allowing the expert neural networks to “specialize” and further improving the efficiency and performance of the neural network.

In some implementations described in this specification, the neural network is a self-attention based neural network. As described in this specification, a self-attention based neural network can require far fewer computations to achieve the same performance as other types of neural networks, e.g., convolutional neural networks. That is, for a fixed compute budget, the self-attention based neural network performs better than the convolutional neural network. This is because applying self-attention is generally more computationally efficient than convolving a kernel across an entire image, as the self-attention mechanism is able to attend to different regions of the network input with fewer computations than convolution.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for processing a block input using an expert block.

FIG. 3 illustrates an example architecture of the neural network.

FIG. 4 illustrates an example architecture of an expert neural network block.

FIG. 5 illustrates an example of generating a final network output using initial network outputs generated using expert neural network blocks.

Like reference numbers and designations in the various drawings indicate like elements.

### DETAILED DESCRIPTION

This specification describes a system implemented as computer programs on one or more computers in one or more locations that performs a machine learning task on a network input to generate a network output for the machine learning task.

The machine learning task can be any machine learning task that operates on a network input that is an input sequence to generate a network output for the network input.

Some examples of machine learning tasks that the system can be configured to perform follow.

As another example, the task may be an audio processing task. For example, if the input to the neural network is a sequence representing a spoken utterance, the output can be a classification output that classifies the spoken utterance into one or more categories from a set of categories. For example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language to generate classification output that classifies the text into one or more categories from a set of categories.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

As another example, the task can be a computer vision task, where the input is an image or a point cloud and the output is a computer vision output for the image or point cloud, e.g., a classification output that includes a respective score for each of a plurality of categories, with each score representing the likelihood that the image or point cloud includes an object belonging to the category.

When the input is an image or point cloud, the neural network can include an embedding subnetwork that generates a respective embedding for each multiple patches of the image or point cloud, and the input to the first block of the neural network can be a sequence that includes the respective embeddings (and, optionally, one or more additional embeddings, e.g., at a predetermined position that will later be used to generate the output). Each patch includes the intensity values of the pixels in a different region of the input image.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

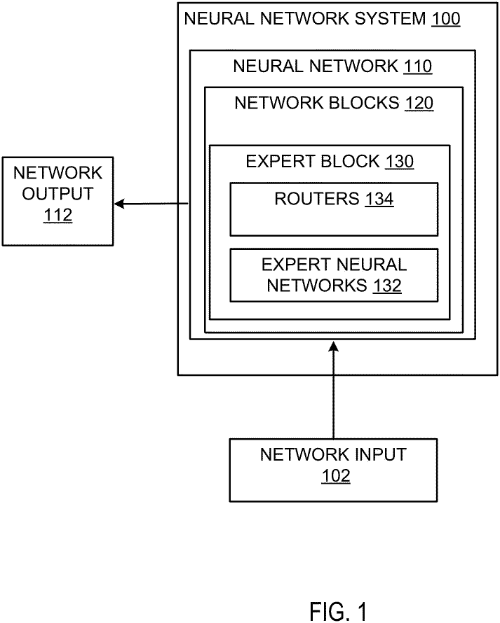

FIG. 1 shows an example neural network system 100. The neural network system 100 is an example of a system implemented as computer programs on one or more computers in one or more locations, in which the systems, components, and techniques described below can be implemented.

The system 100 is a system that processes a network input 102 using a neural network 110 to generate a network output 112 characterizing the network input 102 for a machine learning task, e.g., one of the tasks described above.

The neural network 110 includes a sequence of one or more network blocks 120 that are each configured to process a block input that includes the network input or an intermediate representation of the network input and to generate a block output.

A “network block,” as used in this specification, is a collection of one or more neural network layers that receive an input (“a block input”) and process the input to generate an output (a “block output”).

For example, the first network block in the sequence of network blocks 120 can process the network input 102 to generate a block output that is an intermediate representation of the network input. Each subsequent network block 120 can then process the block output of the previous network block in the sequence.

In some implementations, the network output 112 for the neural network 110 is the block output of the final network block 120 in the sequence.

In some other implementations, the block output of the final network block 120 in the sequence is further processed using one or more neural network layers to generate the network output 112 for the neural network 110.

The sequence of network blocks 120 includes one or more “expert” network blocks 130. Each expert network block 130 includes (i) multiple different expert neural networks 132 and (ii) multiple different routers 134 that are each configured to route the block input of the expert network block 130 (or a router input determined from the block input) to one or more respective expert neural networks 132.

In particular, each expert network block 130 can be configured to obtain a block input and to determine, from the block input, a respective router input for each of the multiple routers 134 of the expert network block 130.

In some implementations, the router input for each router 134 is the same, e.g., is equal to the block input.

In some other implementations, the router input for each router 134 can be different, e.g., can be a different strict subset of the block input.

Example router inputs are discussed in more detail below.

Each router 134 can then process the corresponding router input using a routing subnetwork within the router 134 to assign the router input to one or more of the expert neural networks 132 of the expert network block 130.

For example, the router 134 can generate an output that includes a respective routing score for each expert neural network 132 of the expert network block 130 (or for each strict subset of the expert neural networks of the expert network block, as is discussed in more detail below). The network block 130 can determine to assign the router input to the N expert neural networks 132 corresponding to the N highest routing scores. Generally, N is less than the total number of expert neural networks in the strict subset corresponding to the router 134.

In some implementations, the router 134 randomly samples a noise value to add to each routing score before determining the N highest routing scores.

Instead or in addition, the router 134 can apply a nonlinear activation function, e.g., a softmax, Tanh, or ReLU function, to the routing scores before determining the k highest routing scores.

In some implementations, each router 134 assigns the corresponding router input to a same number N of expert neural networks 132.

In some other implementations, each router 134 can assign the corresponding router input to a different number of expert neural networks 132. For example, a router can assign the corresponding router input to an expert neural network 132 only if the routing score for the expert neural network 132 satisfies a predetermined threshold.

In some such implementations, each router 134 can assign the corresponding router input to up to N expert neural networks 132; that is, if more than N expert neural networks 132 have routing scores satisfying the predetermined threshold, then the router 134 can select the N expert neural networks 132 with the highest routing scores.

The routing subnetwork can include any appropriate configuration of neural network layers.

For example, the router 134 can include one or more feedforward neural network layers. As a particular example, if the router input has dimensionality L × W × C, then the router can reshape the input to have dimensionality 1 × (L • W • C) and process the reshaped input using the feedforward neural network layers.

As another example, the router 134 can include one or more convolutional neural network layers. As a particular example, if a router input has dimensionality L₁ × W₁ × C, then the router can process the router input using a convolutional kernel having dimensionality L₂ × W₂ × C, where L₁ > L₂ and W1 > W₂.

As another example, the router 134 can include one or more self-attention layers. Self-attention is discussed in more detail below.

In some implementations, each router 134 can assign the corresponding router input to expert neural networks 132 in the same set of expert neural networks. That is, the expert network block 130 can have a single “pool” of expert neural networks 132 to which each of the multiple routers 134 of the expert network block 130 assigns respective router inputs.

In some other implementations, each router 134 can assign the corresponding router input to expert neural networks 132 in a different respective set of expert neural networks 132. For example, if there are k routers 134 in the expert network block 132, the set of expert neural networks 134 of the expert network block 132 can be segmented into k disjoint subsets.

After each router 134 has assigned the corresponding router input to one or more respective expert neural networks 132, the expert neural networks 132 can process the assigned router inputs to generate respective expert neural network outputs. For example, each expert neural network 132 can include one or more feedforward neural network layers, one or more convolutional neural network layers, and/or one or more self-attention neural network layers, as described above with reference to the routers 134.

For each router 134, the expert neural network outputs 132 generated from the corresponding router inputs (i.e., the expert neural network outputs generated in response to the router assigning the router input to one or more expert neural networks) can then be combined to generate a router output. For example, the expert network block 130 can determine a sum of the respective expert neural network outputs corresponding to a particular router 134.

In some implementations, the expert network block 130 can combine the router outputs corresponding to respective routers 134 of the expert network block 130 to generate the block output for the expert network block. In some implementations, the expert network block 130 can determine a sum of the router outputs. In some other implementations, the expert network block 130 combines the router outputs by processing the router outputs using one or more neural network layers, e.g., one or more self-attention layers, one or more convolutional neural network layers, and/or one or more recurrent neural network layers.

In some other implementations, the expert network block 130 can generate the block output by concatenating the router outputs.

As a particular example, the neural network 110 can include multiple different expert network blocks 130 that each include k routers.

When processing a particular network input 102, the neural network 110 can maintain k different representations of the network input 102.

At each expert network block 130, the neural network 110 can process a respective different representation of the network input 102 using each of the k routers 132 to generate respective router outputs, as described above; each router output can represent a respective updated representation of the network input. The expert network block 130 can then concatenate the router outputs (i.e., the updated representations) to generate the block output for the expert network block 130, and provide the block output to the next network block 120 in the sequence of network blocks 120.

In other words, for each expert network block 130, the k routers 134 can be assigned an index {1, ..., k}. The block input for the expert network block 130 can include k different sub-inputs (corresponding to respective different representations of the network input), where each sub-input can also be assigned an index {1, ..., k}. The expert network block 130 can then determine the router input for each router to be the sub-input with the same index as the router. The expert network block 130 can concatenate the respective router outputs of the router as described above, thus generating a block output that also includes k sub-outputs having respective indexes {1, ..., k}.

In some implementations, the sequence of network blocks 120 includes expert network blocks 130 interspersed among other types of network blocks, e.g., self-attention network blocks that apply self-attention, that do not include routers and expert neural networks, i.e., that do not perform conditional computation and use all of the parameters of network block for all inputs to the network block. As a particular example, the sequence of network blocks 120 can alternate between expert network blocks and self-attention network blocks. In these implementations, these other types of network blocks can independently process each of the k sub-outputs to update each of the k sub-outputs. Thus, these other types of network blocks are “shared” between all of the k indices.

In particular, when the neural network includes one or more self-attention neural network blocks, the self-attention blocks can apply self-attention to the k representation independently. That is, for each of the k representations, the elements of the representation can attend to each other independently of the other representations. In some such implementations, the neural network 110 can still execute the k attention mechanisms (or more, if each attention mechanism is a multi-headed attention mechanism) in parallel, improving the efficiency of the neural network.

In some of the implementations in which the system maintains k representations of the same network input 102, the final network block 120 in the sequence of network blocks can generate a block output that includes k respective sub-outputs. These k sub-outputs can each represent a respective different prediction for the machine learning task for which the neural network is configured.

The neural network 110 can then combine the k sub-outputs to generate a single final prediction for the machine learning task.

For example, if the sub-outputs each represent a probability distribution over possible predictions, e.g., over classes in a classification machine learning task, then the neural network 110 can determine an average of the probability distributions. As another example, the neural network 110 can determine a sum of the sub-outputs. As another example, the neural network 110 can process the sub-outputs using one or more neural network layers to generate the final prediction. As another example, the neural network 110 can execute a voting algorithm using the k sub-outputs to determine the final prediction.

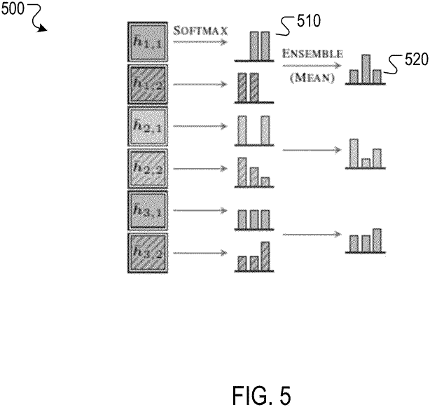

An example of combining sub-outputs is described below with reference to FIG. 5.

In some of the implementations in which the system maintains k representations of the same network input 102, the sequence of network blocks 120 can include multiple other types of “shared” network blocks prior to the first expert block 130 in the sequence. In these implementations, the neural network 110 can maintain a single representation of the network input 102 until the first expert network block 130 in the sequence of network blocks.

That is, when the sequence of network blocks 120 includes one or more other network blocks 120 preceding the first expert network block 130 in the sequence, to save computation, the neural network 110 can save computations by waiting to generate multiple copies of the representation of the network input 102 until the representation is to be processed by the k different routers of the first expert network block in the sequence to generate k respective different router outputs. In other words, the neural network 110 “tiles” the representation of the network input 102 prior to processing the representation using the first expert block 130 to generate k copies of the representation.

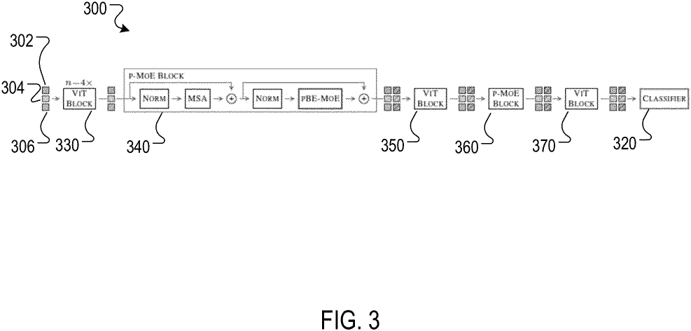

An example of a neural network architecture that includes other types of blocks before the first expert block is described below with reference to FIG. 3.

Generally, the network input 102 is a sequence that includes multiple input elements at respective input positions and the block inputs to each of the blocks 120 in the sequence are also sequences with the same number of inputs. That is, each block 120 updates each of the elements in the block input sequence to generate the block output for the block 120.

To account for this, each expert network block 130 can process each input element (or router inputs generated from the input element) using the routers 134 as described above to generate a respective output element. The block output of the expert network block 130 can thus be a sequence including, for each input position, the corresponding generated output element.

That is, when there are k representations of the network input 102, the neural network 101 maintains k representations of each element in the input sequence.

In some implementations, not every expert neural network 132 of an expert network block 130 processes a router input of a given block input (i.e., some expert neural networks 132 of the expert network block 130 are idle for a given block input). This can improve the efficiency of the network 110 by reducing the number of computations required to generate a network output 112, as not every parameter of the network 110 is used to process each network input 102. The routers 134 of the expert network block 130 can be trained to assign the corresponding router inputs to the expert neural network 132 that will extract the most information from the router inputs. That is, in some implementations, some expert neural networks 132 can “specialize” in certain types of inputs.

As mentioned above, in some implementations the sequence of network blocks includes one or more network blocks that are not expert blocks. For example, the sequence of network blocks can include one or more self-attention network blocks that are configured to process a block input using one or more self-attention neural network layers.

A self-attention neural network layer receives as input a sequence of input elements and applies an attention mechanism over the sequence of input elements to generate a sequence of layer outputs elements. In particular, for each input element, the self-attention neural network layer applies the attention mechanism over the sequence of input elements using one or more queries derived from the input element to generate a respective output element. Some self-attention neural network layers are multi-head self-attention neural network layers. A multi-head self-attention neural network layer applies h different attention mechanisms in parallel to generate respective sequences of output elements, and then combines the multiple sequences of output elements to generate a final sequence of output elements.

Self-attention is described in more detail below.

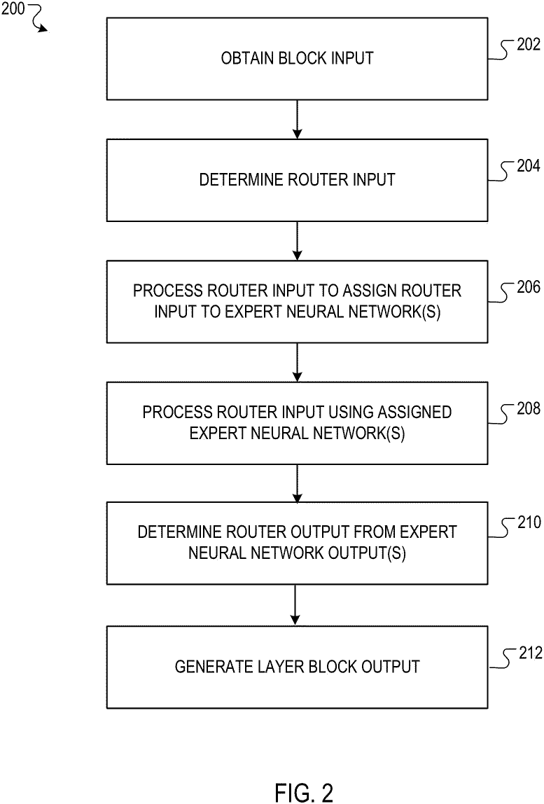

FIG. 2 is a flow diagram 200 of an example process for processing a block input using an expert block. For convenience, the process 200 will be described as being performed by a system of one or more computers located in one or more locations. For example, an expert block included in a neural network system, e.g., one of the expert blocks 130 included in the neural network system 100 of FIG. 1, appropriately programmed, can perform the process 200.

The expert block obtains a block input that represents an intermediate representation of the network input (step 202). As described above, the block input can include either a single representation of the network input or k different representations of the network input.

The expert block then performs steps 204-210 for each router in the expert block.

The expert block determines a respective router input for the router from the block input (step 204). When the block input can includes a single representation of the network input, each router input can be the same and can be equal to the block input. When the block input includes k different representations of the network input, each of the routers receives a corresponding one of the k representations, i.e., receives the representation that has an index that matches the index of the router.

The expert block processes the router input for the router using one or more neural network layers of the router, i.e., the routing subnetwork for the router, to assign the router input to one or more expert neural networks of a plurality of expert neural networks of the expert network block (step 206). That is, the routing subnetwork generates a respective routing score for each expert neural network that is assigned to the router and the expert block can select a proper subset of the expert neural networks using the routing scores.

For each of the one or more assigned expert neural networks, the expert block processes the router input for the router using the expert neural network to generate a respective expert neural network output (step 208).

The expert block determines a router output from the one or more expert neural network outputs (step 210). When there are multiple expert neural network outputs, the expert block can combine the expert outputs as described above to generate the router output.

The expert block then generates a block output by combining the respective router outputs corresponding to the plurality of routers (step 212). For example, when the neural network maintains k different representations of the network input, the expert block can concatenate the router outputs to generate the block output.

FIG. 3 shows an example architecture of the neural network 110.

In particular, FIG. 3 shows the processing of three network inputs 302, 304, and 306 using the neural network 110 to generate a respective network output for each of the three inputs.

While in the description of FIG. 3, each network input is represented as a single element, more generally, each network input will be a sequence of multiple elements. Generally, at least some of the elements will represent a respective portion of the corresponding network input. Optionally, the elements will also include a “class” element that is appended onto the sequence by the neural network 110. The representations of the “class” element are then used by a classifier 320 within the neural network 110 to generate the network output for the network input.

As shown in FIG. 3, the neural network 110 includes a sequence of n blocks 120. The first n - 4 blocks are ViT blocks 330. A ViT block is a Vision Transformer self-attention block for processing representations of images. When the network inputs are not images, these blocks 330 can be replaced with other types of self-attention blocks.

Each ViT block 330 processes a single representation of each of the network inputs 302, 304, and 306 and the output of the last ViT block 330 is a single updated representation of each of the network inputs.

After the first n - 4 ViT blocks 330, the neural network 110 includes four more blocks 120: a first expert block 340, a ViT block 350, a second expert block 360, and a final ViT block 370.

Each of these blocks 340, 350, 360, and 370 operates on k = 2 representations of each of the network inputs.

For the blocks 350 and 370 that do not include conditional computation, each component of each of the blocks independently processes each of the representations of the network input.

After the processing of the block 370, the k final representations of each of the network inputs are provided to the classifier 320 for use in generating a final network output for each of the network inputs.

This is described in more detail below with reference to FIG. 5.

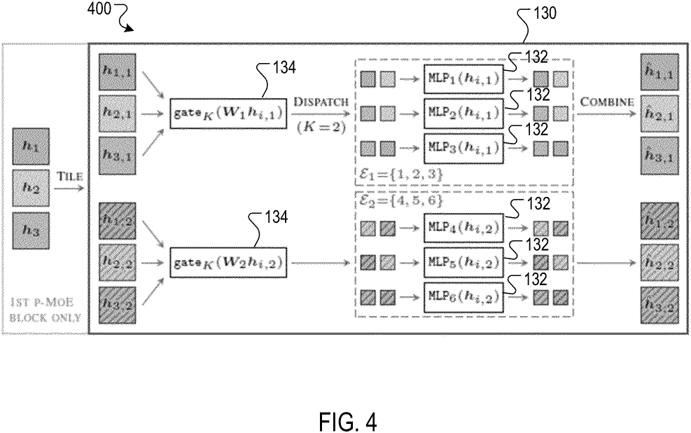

As shown in FIG. 3, the expert block 340 (referred to as a “p-MOE block”) includes additional operations in addition to those described above as being performed by an expert block. These expert block operations, as will be evident from the description of FIG. 4, are included within the “pBE-MOE” sub-block 342 in FIG. 3. Equivalently, these other operations, i.e., normalization operations (“norm”), multi-head self-attention (“MSA”), and residual connections (“⊕”) can be viewed as being performed by separate blocks of the neural network 110. That is, although the sub-block 342 is shown in FIG. 3 as being part of a larger block 340, in practice, the sub-block 342 can be an expert block that receives as input the outputs of one block 344 that applies a normalization, e.g., LayerNorm, and provides an output to another block 346 that computes a residual connection on the input to the block.

FIG. 4 illustrates an example architecture of an expert neural network block 130.

Like in the example of FIG. 3, in the example of FIG. 4, the block 130 is shown as operating on a single representation of each of the inputs 302, 304, and 306.

When the block 130 is the first expert block in the sequence, the block 130 “tiles” each of the representations to generate k = 2 copies of each of the representations, one for each of the routers 134 within the expert block.

That is, the expert block includes k = 2 routers 134. The expert block also includes six expert neural networks 132. The expert neural networks 132 are partitioned so that three of the experts correspond to one of the routers and the other experts correspond to the other router.

To generate an output for a given network input, the block 130 provides the first representation of the input to the first router 134 and provides the second representation to the second router 134.

Each router 134 processes the representation that is provided to the router using a routing subnetwork. In the example of FIG. 4, this is a linear neural network layer. The output of the routing subnetwork is a respective score for each of the experts that are assigned to the router.

The router 134 then assigns (‘dispatches’) each representation to at most K=2 of the experts.

Each expert neural network (which, in the example of FIG. 4, is an MLP) processes the representations that are assigned to the expert to generate an expert output and the block 130 combines the expert outputs for each of the representations so that the block output again includes k=2 representations of each network input.

FIG. 5 shows an example 500 of generating a final network output. For example, FIG. 5 can show the processing performed by the classifier 320 of FIG. 3.

As shown in FIG. 5, the classifier receives k =2 representations for each network input. The classifier 320 then applies one or more operations to each representation to generate an initial network output 510 for each representation. For example, for each representation, the classifier 320 can apply one or more linear layers followed by a softmax operation on the final representation of the “class” element within the representation to generate the initial network output for the representation. As another example, for each representation, the classifier 320 can apply one or more linear layers followed by a softmax operation on a pooled representation generated by pooling the final representations within the representation to generate the initial network output for the representation. For any given network input, the classifier then ensembles the initial network outputs 510 for the representations of the network input to generate the final network output 520 for the network input. For example, the classifier can combine the initial network outputs using any of the techniques described above with reference to FIG. 1.

Prior to using the neural network to perform the machine learning task, a training system trains the neural network to perform the task, i.e., to determine trained values of the parameters of the neural network, i.e., of the blocks in the sequence, the classifier, and, optionally, an embedding subnetwork used to generate the input to the first block in the sequence. For example, the training system can train the neural network from scratch on training data for the task to minimize a loss function for the task, e.g., a cross-entropy loss, a negative log likelihood loss, and so on using conventional machine learning techniques. As another example, the training system can first pre-train the neural network on an unsupervised objective and then fine-tune the neural network on the training data for the task. As yet another example, the training system can train the neural network on both unlabeled data and the training data for the task through semi-supervised learning.

During training, the training system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the neural network in parallel. Moreover, as described above, the system can first pre-train the neural network on a large unsupervised data set through unsupervised learning, e.g., to minimize a BERT loss or other unsupervised loss, and then fine-tune the neural network on task-specific training data to optimize the loss function for the task.

An “embedding,” as used in this specification is a vector of numeric values, e.g., floating point or other type of numeric values, that has a predetermined dimensionality, e.g., has a predetermined number of values.

A self-attention block, as referred to above, is a neural network layer that includes an attention mechanism that operates over the self-attention block input (or an input derived from the layer input) to generate the self-attention block output. A self-attention mechanism may be causally masked so that any given position in an input sequence does not attend over (e.g., use data from) any positions after the given position in the input sequence. There are many different possible attention mechanisms. Some examples of self-attention layers including attention mechanisms, are described in Vaswani et al. “Attention is all you need”, 31st Conference on Neural Information Processing Systems (NIPS 2017), Long Beach, CA, USA; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell et al. Language models are few-shot learners. arXiv preprint arXiv:2005.14165, 2020.

Generally, an attention mechanism maps a query and a set of key-value pairs to an output, where the query, keys, and values are all vectors. The output is computed as a weighted sum of the values, where the weight assigned to each value is computed by a compatibility function, e.g., a dot product or scaled dot product, of the query with the corresponding key.

Generally, a self-attention mechanism is configured to relate different positions in the same sequence to determine a transformed version of the sequence as an output. For example the attention layer input may comprise a vector for each element of the input sequence. These vectors provide an input to the self-attention mechanism and are used by the self-attention mechanism to determine a new representation of the same sequence for the attention layer output, which similarly comprises a vector for each element of the input sequence. An output of the self-attention mechanism may be used as the attention layer output, or it may be processed by one or more of feed-forward layers, skip connections, or normalization operations to provide the attention layer output.

In some implementations the attention mechanism is configured to apply each of a query transformation, e.g., defined by a matrix W^{Q}, a key transformation, e.g., defined by a matrix W^{K}, and a value transformation, e.g., defined by a matrix W^{V}, to the attention layer input which is the input data X to the attention layer, to derive a query matrix Q = XW^{Q} that includes a respective query for each vector in the input sequence, key matrix K = XW^{K} that includes a respective key for each vector in the input sequence, and value matrix V = XW^{V} that includes a respective value for each vector in the input sequence, which are used determine an attended sequence for the output. For example the attention mechanism may be a dot product attention mechanism applied by applying each query vector to each key vector to determine respective weights for each value vector, then combining the value vectors using the respective weights to determine the self-attention layer output for each element of the input sequence. The self-attention layer output may be scaled by a scaling factor, e.g., by the square root of the dimensions of the queries and keys, to implement scaled dot product attention. Thus, for example, an output of the attention mechanism may be determined as softmax

$$\left(\frac{Q {K}^{T}}{\sqrt{d}}\right) \text{V}$$

where d is a dimension of the key (and value) vector. In another implementation the attention mechanism be comprise an “additive attention” mechanism that computes the compatibility function using a feed-forward network with a hidden layer. The output of the attention mechanism may be further processed by one or more fully-connected, feed forward neural network layers.

The attention mechanism may implement multi-head attention, that is, it may apply multiple different attention mechanisms in parallel. The outputs of these may then be combined, e.g., concatenated, with a learned linear transformation applied to reduce to the original dimensionality if necessary.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A system comprising one or more computers and one or more storage devices storing instructions that when executed by the one or more computers cause the one or more computers implement a neural network that is configured to process a network input and to generate a network output for the network input, the neural network comprising a sequence of one or more network blocks, the sequence comprising one or more expert network blocks configured to perform operations comprising:
obtaining a block input that represents an intermediate representation of the network input;
for each of a plurality of routers of the expert network block:
determining a respective router input from the block input;
processing the router input using one or more neural network layers of the router to assign the router input to one or more expert neural networks of a plurality of expert neural networks of the expert network block;
for each of the one or more assigned expert neural networks, processing the router input using the expert neural network to generate a respective expert neural network output; and
determining a router output from the one or more expert neural network outputs; and
generating a block output by combining the respective router outputs corresponding to the plurality of routers.

2. The system of claim 1, wherein:
the sequence of network blocks comprises a plurality of expert network blocks,
each expert network block has a same number k of routers that are each assigned a different respective index in {1, ..., k}, and
for at least a subset of the plurality of expert network blocks:
the expert network block is configured to obtain a block input comprising k sub-inputs that are each assigned a different respective index in {1, ..., k}, and
for each of the k routers of the expert network block, determining a respective router input from the block input comprises identifying the sub-input with the same index as the router.

3. The system of claim 2, wherein:
for a first expert network block in the sequence of network blocks, the respective router input for each router is the same; and
for each subsequent expert network block in the sequence of network blocks, the respective router input for each router is different.

4. The system of claim 1, wherein:
for at least a second subset of the one or more expert network blocks:
generating a block output for the expert network block comprises concatenating the respective router outputs of the plurality of routers of the expert network block.

5. The system of claim 1, wherein:
for at least a third subset of the one or more expert network blocks:
generating a block output for the expert network block comprises determining a sum of the respective router outputs of the plurality of routers of the expert network block.

6. The system of claim 1, wherein:
for at least a fourth subset of the one or more expert network blocks:
each router of the expert network block is configured to assign the corresponding router inputs to expert neural networks in a respective different disjoint set of expert neural networks determined from the plurality of expert neural networks of the expert network block.

7. The system of claim 1, wherein:
for at least a fifth subset of the one or more expert network blocks:
each router of the expert network block is configured to assign the corresponding router inputs to any expert neural network of the plurality of expert neural networks of the expert network block.

8. The system of claim 1, wherein each router of each expert network block assigns the corresponding router inputs to a same number of expert neural networks.

9. The system of claim 1, wherein the sequence of network blocks further comprises one or more self-attention network blocks that are each configured to perform operations comprising:
obtaining a self-attention block input comprising a sequence of input elements;
applying a self-attention mechanism to the input elements or to respective updated representations of the input elements to generate a self-attention block output.

10. The system of claim 9, wherein the sequence of network blocks alternates between expert network blocks and self-attention network blocks.

11. The system of claim 1, wherein for each expert network block, the operations of the plurality of routers of the expert network block are executed in parallel.

12. The system of claim 1, wherein for each router of each network block, processing the corresponding router input using the assigned expert neural networks comprises processing the corresponding router input using each assigned expert neural network in parallel.

13. One or more non-transitory computer-readable storage media storing instructions that when executed by one or more computers cause the one or more computers implement a neural network that is configured to process a network input and to generate a network output for the network input, the neural network comprising a sequence of one or more network blocks, the sequence comprising one or more expert network blocks configured to perform operations comprising:
obtaining a block input that represents an intermediate representation of the network input;
for each of a plurality of routers of the expert network block:
determining a respective router input from the block input;
processing the router input using one or more neural network layers of the router to assign the router input to one or more expert neural networks of a plurality of expert neural networks of the expert network block;
for each of the one or more assigned expert neural networks, processing the router input using the expert neural network to generate a respective expert neural network output; and
determining a router output from the one or more expert neural network outputs; and
generating a block output by combining the respective router outputs corresponding to the plurality of routers.

14. A method performed by one or more computers, the method comprising:
receiving a network input; and
generating a network output for the network input by processing the network input using a neural network, the neural network comprising a sequence of one or more network blocks, the sequence comprising one or more expert network blocks that are each configured to perform operations comprising:
obtaining a block input that represents an intermediate representation of the network input;
for each of a plurality of routers of the expert network block:
determining a respective router input from the block input;
processing the router input using one or more neural network layers of the router to assign the router input to one or more expert neural networks of a plurality of expert neural networks of the expert network block;
for each of the one or more assigned expert neural networks, processing the router input using the expert neural network to generate a respective expert neural network output; and
determining a router output from the one or more expert neural network outputs; and
generating a block output by combining the respective router outputs corresponding to the plurality of routers.

15. The method of claim 14, wherein:
the sequence of network blocks comprises a plurality of expert network blocks,
each expert network block has a same number k of routers that are each assigned a different respective index in {1, ..., k}, and
for at least a subset of the plurality of expert network blocks:
the expert network block is configured to obtain a block input comprising k sub-inputs that are each assigned a different respective index in {1, ..., k}, and
for each of the k routers of the expert network block, determining a respective router input from the block input comprises identifying the sub-input with the same index as the router.

16. The method of claim 15, wherein:
for a first expert network block in the sequence of network blocks, the respective router input for each router is the same; and
for each subsequent expert network block in the sequence of network blocks, the respective router input for each router is different.

17. The method of claim 15, wherein:
for at least a second subset of the one or more expert network blocks:
generating a block output for the expert network block comprises concatenating the respective router outputs of the plurality of routers of the expert network block.

18. The method of claim 14, wherein:
for at least a third subset of the one or more expert network blocks:
generating a block output for the expert network block comprises determining a sum of the respective router outputs of the plurality of routers of the expert network block.

19. The method of claim 14, wherein:
for at least a fourth subset of the one or more expert network blocks:
each router of the expert network block is configured to assign the corresponding router inputs to expert neural networks in a respective different disjoint set of expert neural networks determined from the plurality of expert neural networks of the expert network block.

20. The method of claim 14, wherein:
for at least a fifth subset of the one or more expert network blocks:
each router of the expert network block is configured to assign the corresponding router inputs to any expert neural network of the plurality of expert neural networks of the expert network block.
